(19) United States
(12) Patent Application Publication
(10) Pub. No.: US 2008/0027813 A1
(43) Pub. Date: Jan. 31, 2008

(54) Apparatus and method and computer program product for distributing advertisement

(75) Inventors: Chikaaki Kogure, Tenri-shi (JP); Norihiro Ochi, Sakurai-shi (JP); Hideaki Kohi, Kitakatsuragi-gun (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 11/878,447

(22) Filed: Jul. 24, 2007

(30) Foreign Application Priority Data
Jul. 27, 2006 (JP) 2006-204509(P)

(51) Int. Cl. G06Q 30/00; G06F 13/00; H04Q 7/38

(52) U.S. Cl. 705/14

(57) ABSTRACT

An advertisement data server includes: an URL database storing URLs different for different products and information on whether each product has been sold or not; a URL comparing unit, when accessed by a terminal, for making reference to the URL database for determining whether the corresponding product has been sold or not; an image data transmitting unit for transmitting an advertisement image to the terminal for display if the product has been sold; a time calculating unit for calculating the time period in which the advertisement image is displayed on the terminal; and a refund amount calculating unit for calculating, based on the product, the time of display of the advertisement image and on the information stored in the URL database, an amount to be returned to the owner of the terminal on behalf of viewing the advertisement image.

### CROSS-REFERENCE TO RELATED APPLICATION

This non-provisional application claims priority under 35 U.S.C. § 119(a) on Patent Application No. 2006-204509 filed in Japan on Jul. 27, 2006, the entire contents of which are hereby incorporated by reference.

### BACKGROUND OF THE INVENTION

1. Field of the Invention

The present invention relates to an advertisement data server and, more specifically, to an apparatus, method and a computer program product for distributing advertisement to terminals on a network such as mobile communication terminals, while communicating with the terminals.

2. Description of the Background Art

Recently, portable devices come to have ever higher functions and, as a result, power consumed at the time of operation of the portable devices is increasing. By way of example, a portable telephone, which is one of the most widely used portable devices, consumes more power at the time of operation, as it comes to have larger number of functions and higher performance, including higher image quality of display, higher camera functions and TV functions.

In view of the foregoing, various batteries having high energy density have been explored to maintain or improve continuous operation time. Among such batteries, a fuel cell is considered very promising as energy for portable devices these days, as it has high energy density and allows continuous use as long as fuel supply is continued.

Among fuel cells, a polymer electrolyte fuel cell has been considered particularly suitable for portable devices. The reason is that a polymer electrolyte fuel cell has reaction temperature not higher than 100° C., and operation temperature is lower than other fuel cells such as solid oxide fuel cell and phosphoric-acid fuel cell.

Among the polymer electrolyte fuel cells having such characteristics, a direct methanol fuel cell (DMFC) is particularly expected as a battery that can replace lithium battery. Energy density of methanol, which is the fuel of DMFC, is a number of times higher than that of a lithium battery, and methanol has specific gravity of 0.79. Therefore, DMFC allows reduction in weight of the battery and hence the weight of the portable device. Further, the fuel of DMFC is liquid methanol, and hence, it is unnecessary to produce batteries of different shapes for different devices. Specifically, what is necessary is to form fuel containers of different shapes as housings for holding the fuel, and simply by introducing methanol to the containers, batteries are finished.

There are two main methods of replenishing fuel of the DMFC, that is, container exchange type and injection type, dependent on difference in placement of fuel container to the fuel cell. When the fuel container is separable from the fuel cell, the container exchange method is available, in which a fuel cartridge is replaced with one filled with the fuel for replenishment. When the fuel container is inseparable from the fuel cell, injection method is adopted, in which, when the fuel container becomes empty, fuel is taken out from a fuel bottle and introduced to the fuel container integrated with the fuel cell, using an injector or the like.

Though the fuel cell itself is promising as a power source of the future, wide spread use thereof has not been attained. One of the factors preventing popular use is its prohibitive price. Compared with other batteries, a fuel cell is relatively too expensive to replace other batteries. In this regard, an approach may be made to reduce the cost of fuel in return for posting an advertisement on the fuel container. Specifically, the fuel price is reduced by the amount of advertisement expenses, to help promote wider use of devices with fuel cells.

Among the fuel cells allowing fuel container exchange, one has been known as disclosed in Japanese Patent No. 3683875, in which an information function element is added to the fuel cartridge. According to Japanese Patent No. 3683875, information such as fuel remaining amount stored in an information storage element is shown on a display, improving convenience of the user. Utilizing such a technique, it is possible to post an advertisement on the display, by storing advertising images and the like in the information storage element added to the fuel cartridge.

Other than the method described above, there are various media for placing advertisement to users. By way of example, pocket tissues with advertisement or information magazine with coupons may be handed out. These are examples of profit-returning advertisement and a customer receiving the advertisement can enjoy the economic benefit such as the pocket tissue or coupons.

Portable telephones are also used for such profit-returning advertisement. By way of example, Japanese Patent No. 3315966 discloses a method of profit-returning type advertisement using a portable telephone. Specifically, according to the disclosed technique, advertisement is added to ring tone and incoming call screen, and communication fees is reduced in accordance with the state of advertisement reception.

### SUMMARY OF THE INVENTION

According to the technique disclosed in Japanese Patent No. 3683875, however, a special element is added to the fuel cartridge, and hence, it entails extra cost in fabricating the fuel cartridge. As a result, sales price of the fuel cell also increases. Further, users accustomed to use devices operating with secondary batteries charged from AC (alternating current) power source, with which energy cost on portable communication devices can be made almost negligible, are expected to be hesitant to buy fuel. Therefore, fuel as the energy should preferably be used at a lowest possible cost.

According to the technique disclosed in Japanese Patent No. 3315966, when commercial information is transmitted to a user using a commercial song, a melody with commercial sound message or the like as a ring tone, the effect of advertisement would be diminished if the portable telephone is set in a vibration mode. Further, a user commonly wishes to answer an incoming call immediately. Therefore, few users may pay close attention to the advertisement upon receiving a call. Further, when the advertisement information is transmitted as a ring tone at the time of receiving a call, the effect of advertisement is not very high for a user not receiving many calls or mails. It is impossible solely by the technique to realize a method of returning the cost of fuel cell only to the users who purchased the fuel cell.

Therefore, an object of the present invention is to provide apparatus and method of distributing advertisement for realizing a system in which advertisement information can be transmitted by a simple arrangement, and the cost of a product can be taken over by an advertiser in return for sending highly effective advertisement to the user.

Another object of the present invention is to provide apparatus and method of distributing advertisement for realizing a system in which advertisement information can be transmitted by a simple arrangement, and the cost of a fuel cell can be taken over by an advertiser in return for sending highly effective advertisement to the user.

According to a first aspect of the present invention, an apparatus for distributing advertisement to a terminal on a network includes: a first storage for individually storing a flag indicating whether each of a plurality of products has been sold or not by first and second values, respectively; a determining unit responsive to an access from outside designating prescribed information allotted to the plurality of products and different for different products, for determining whether the product specified by the prescribed information has been sold or not, by making reference to the first storage; a transmitting unit responsive to a determination by the determining unit that the corresponding product has been sold, for transmitting an advertisement image prepared beforehand to a terminal that made the access; a measuring unit for measuring a time period in which the advertisement image is displayed on the terminal, through communication with the terminal; and an amount calculating unit for calculating an amount to be paid back to an owner of the terminal in return for viewing the advertisement image, based on the time period measured by the measuring unit and on the prescribed information.

Preferably, the product on the advertisement data server described above is a fuel cell cartridge.

Using the sales price of fuel cell cartridge as a reference, the amount calculating unit calculates an amount of refund to the user. Thus, the cost on the fuel cell cartridge is refunded. As a result, substantial burden on the user can be alleviated, and the user would be less hesitant to purchase a fuel cell cartridge.

According to a second aspect of the present invention, a computerized method of distributing advertisement to a terminal on a network includes the steps of: connecting to a first storage for individually storing a flag indicating whether each of products in a predetermined group of products has been sold or not by first and second values, respectively; determining, in response an access designating prescribed information allotted to the plurality of products and different for different products from outside, whether the flag of the product specified by the prescribed information has the first value or not, by making reference to the first storage; transmitting, in response to determination at the determining step that the flag of the corresponding product has the first value, an advertisement image prepared beforehand to a terminal device that made the access; measuring a time period in which the advertisement image is displayed in the terminal device, through communication with the terminal device; and calculating, based on the prescribed information and the time period measured at the measuring step, an amount to be paid to an owner of the terminal device in return for viewing the advertisement image.

According to a third aspect of the present invention, a computer program product is provided having a computer-readable medium having recorded thereon a computer program for distributing advertisement to a terminal on a network, wherein the computer program product includes a first program code unit for connecting to first storage in the computer for individually storing a flag indicating whether each of products of a predetermined product group has been sold or not by first and second values, respectively, a second program code unit responsive to an access designating prescribed information allotted to the products and different for different products from outside, for determining whether the product specified by the prescribed information has been sold or not, by making reference to the first storage, a third program code unit responsive to determination by the second program code unit that the corresponding product has been sold, for transmitting an advertisement image prepared beforehand to a terminal device that made the access, a fourth program code unit for measuring a time period in which the advertisement image is displayed in the terminal device, through communication with the terminal device, and a fifth program code unit for calculating, based on the prescribed information and the time period measured at the measuring step, an amount to be paid to an owner of the terminal device in return for viewing the advertisement image.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram representing a configuration of a fuel cell price refund system 20.

FIG. 2 is a block diagram representing a schematic configuration of the system at a telecommunications company 32.

FIG. 3 is a block diagram representing a configuration of an advertisement data server 72.

FIG. 4 shows an example of URL data stored in a URL database 102.

FIG. 5 shows an example of product code data stored in a product database 104.

FIG. 6 shows an example as to how the URL is attached to a fuel cell.

FIG. 7 shows another example as to how the URL is attached to a fuel cell.

FIG. 8 shows an appearance of a computer system implementing advertisement data server 72 in accordance with an embodiment of the present invention.

FIG. 9 is a block diagram of the computer shown in FIG. 8.

FIG. 10 is a flowchart representing a process procedure when a lock setting process at a portable telephone 80 is executed by a computer program.

FIG. 11 is a flowchart representing a process procedure when an unlock process at portable telephone 80 is executed by a computer program.

FIG. 12 is a flowchart representing a process procedure when a lock setting process at advertisement data server 72 is executed by a computer program.

FIG. 13 is a flowchart representing a process procedure when an unlock process at advertisement data server 72 is executed by a computer program.

### DESCRIPTION OF THE PREFERRED EMBODIMENTS

[Configuration]

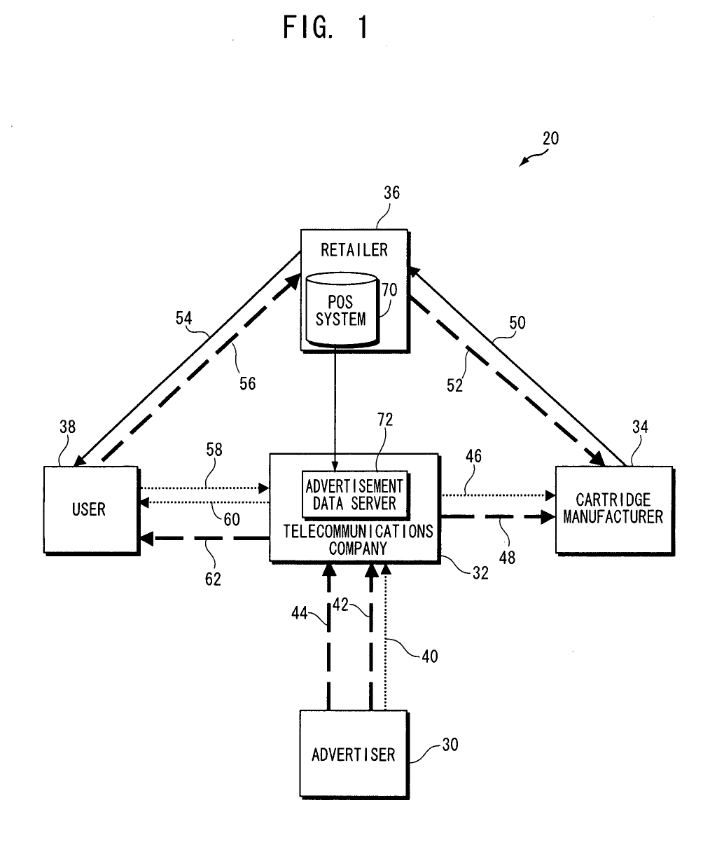

Prior to the description of the configuration of advertisement data server in accordance with an embodiment, the fuel cell price refund system using the advertisement data server will be described. FIG. 1 is a block diagram showing the configuration of fuel cell price refund system 20.

Referring to FIG. 1, fuel cell price refund system 20 includes: an advertiser 30 making an order 40 to place an advertisement, paying cost 42 to run an advertisement, and paying the price 44 of fuel cartridge on behalf of a user who looked the advertisement, as a consideration; and a telecommunications company 32 receiving the order 40 to place an advertisement from advertiser 30, having advertisement data including an advertisement image formed to order stored in advertisement data server 72, passing URL (Uniform Resource Locator) data 46 to obtain the advertisement image to a fuel cartridge manufacturer, and paying printing fee 48.

Fuel cell price refund system 20 further includes: a fuel cartridge manufacturer 34 manufacturing and selling a fuel cartridge 50 having URL data 46 printed on its container or wrapping and receiving payment of fuel cartridge price 52; and a retailer 36 buying fuel cartridge 50 from cartridge manufacturer 34 and paying the price 52, and selling the fuel cartridge further to a user 38 at a price 56. Retailer 36 has a POS (Point of Sale) system 70 for reading information of the fuel cartridge it sells from the container or the wrapper, and transmitting the information to advertisement data server 72.

There is a user 38 of fuel cell price refund system 20. The user first buys fuel cartridge 54 from retailer 36 and pays the price 56 of fuel cartridge. In the present embodiment, user 38 manually inputs URL data 58 printed on the container and wrapper of fuel cartridge, for obtaining advertisement image, and transmits the data to advertisement data server 72. User 38 receives advertisement data 60 including an advertisement image, returned from advertisement data server 72 in response to the data transmission, and displays the image as a standby display of the portable telephone. Then, in response to a lock signal from advertisement data server 72, the advertisement image is locked as the standby display of the portable telephone, and the advertisement image is kept displayed as the standby image until the user 38 makes an unlock request. When the user 38 makes an unlock request, advertisement data server 72 transmits an unlock signal instructing unlocking (lock cancellation) of the standby image, to the portable telephone. Further, the telecommunications company measures the time period in which the advertisement was displayed as the standby image, and in accordance with the measured time period, refunds 62 the price of fuel cartridge in return for the display of advertisement data 60. In the present embodiment, it is assumed that user 38 uses the portable telephone through a portable telephone service provided by telecommunications company 32, and that the price of fuel cartridge is reduced from the communication fees of the user 38 and returned to the user 38.

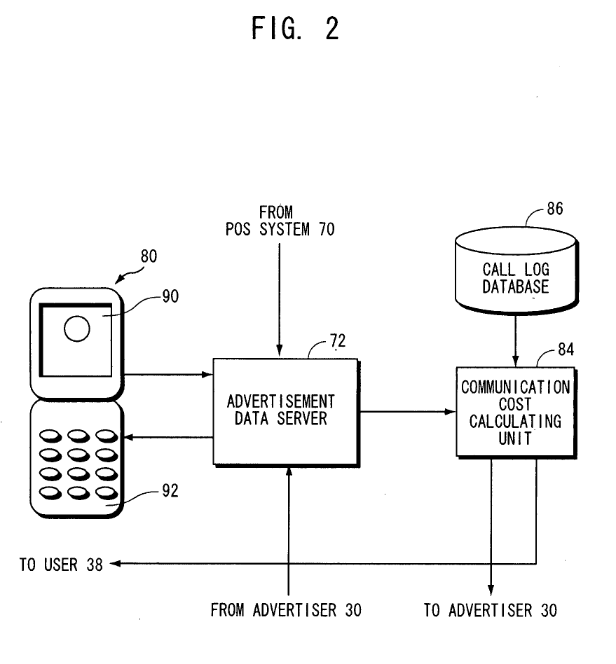

FIG. 2 is a block diagram schematically showing the system at telecommunications company 32. The system of telecommunications company 32 includes advertisement data server 72 having a function of communicating with a portable telephone 80 of user 38, transmitting the advertisement data to portable telephone 80 based on a key operation of portable telephone 80 and on POS data, and notifying the amount of refund that can be received by the user 38 in return for the display of advertisement. Specifically, by advertisement data server 72, the advertisement is distributed to portable telephones on the network.

The system further includes a call log database 86 storing call log data necessary for calculating general communication fees based on the time of communication, and a communication cost calculating unit 84 outputting the amount of refund in consideration of advertisement display per month calculated based on the result of refund calculation output from advertisement data server 72 and charging the user 38 for the communication fees with the amount of refund per month reduced.

Communication cost calculating unit 84 accumulates itemized records of refund, calculates the amount of refund user by user from the itemized records on a specific cut-off date, and performs a prescribed accounting procedure on the result of calculation and the communication fees calculated based on the time of communication of the user 38 stored in call log database 86. Specifically, communication cost calculating unit 84 balances out the amount of refund and the communication fees. By this counterbalance, the amount of refund is reduced from the monthly charge of communication fees of the user 38. Further, the itemized records contain sponsor codes, terminal IDs and the like. The sponsor code is a piece of information representing who is the sponsor of the advertisement image displayed on the screen of portable telephone 80 of the user 38 when the corresponding URL is input. The itemized records and the result of adding up the amounts of refund of every sponsor code are transmitted, together with a bill, to advertiser 30.

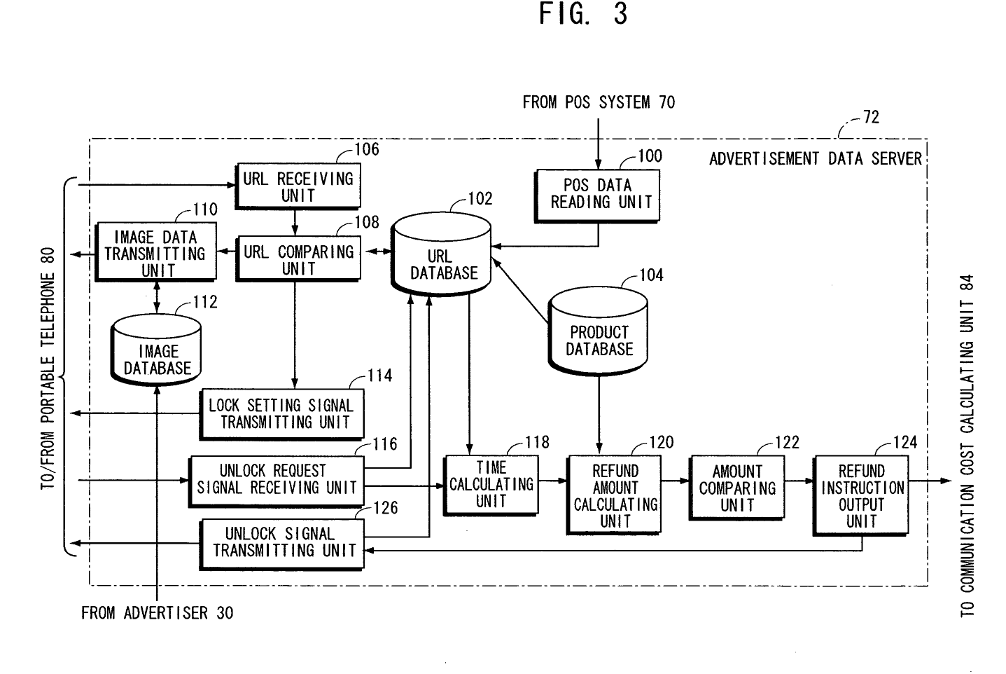

FIG. 3 is a block diagram showing the configuration of advertisement data server 72. Referring to FIG. 3, advertisement data server 72 includes a URL database 102 storing in advance URL data consisting of a plurality of records each associated with a unique URL, and a product database 104 storing basic information related to the fuel cartridge.

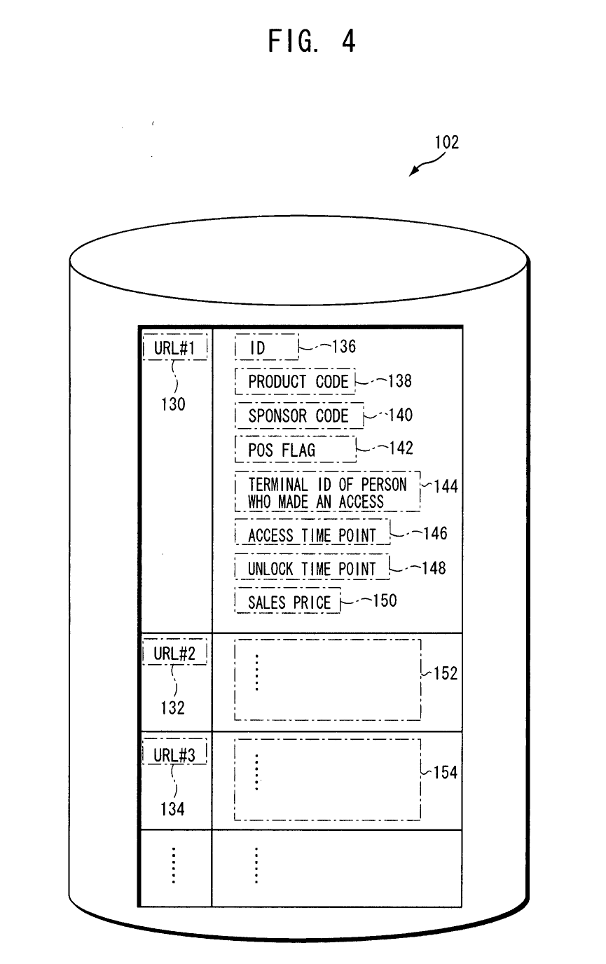

FIG. 4 shows an example of URL data stored in URL database 102. FIG. 4 shows three records. Referring to FIG. 4, entries 130 to 134 represent URL addresses. Here, by way of example, three different URL addresses URL#1, URL#2 and URL#3 are listed. The URL address corresponds to an individual product as an object, and differs product by product.

An item 136 represents ID (Identification Data) of URL#1. Different URLs can be identified by the IDs.

An item 138 represents a product code. Using the product code as a key, product database 104 may be accessed to get information related to the product. Examples of information added to the product code will be described later.

An item 140 represents the sponsor code. Based on the sponsor code, telecommunications company charges the sponsor for the amount retuned to the user.

An item 142 represents a POS flag. When a fuel cartridge having the URL printed on it is purchased, POS system processing is done. The POS flag represents whether the corresponding fuel cartridge has been subjected to POS system processing or not, that is, whether the fuel cartridge has been sold or not. In the present embodiment, the state after POS system processing is represented by the value “1” and the state before POS system processing is represented by the value “0” of the POS flag.

POS flag not being “1” means that the fuel cartridge has not been purchased. If the POS flag in the URL record corresponding to the URL transmitted from a portable telephone 80 is not “1”, it is highly likely that the URL only is stolen on a store shelf. Thus, whether refund could be made or not is determined dependent on whether the POS flag is “1” or not.

An item 144 represents a terminal ID for identifying a terminal of the user who made the access. This information is written when a user accesses the URL of the record from his/her portable telephone. If item 144 is empty, it means that no access to the URL has been made, and if it is not empty, it means that an access has already been made. Generally, a plurality of accesses made to a URL attached to one fuel cartridge suggests some wrongful action such as theft of the URL. Further, one user may access to the same URL a number of times to get refund repeatedly. Further, as will be described later, in order to unlock the advertisement image and to calculate the amount of refund, it must be confirmed that the user who made the access first and the user who made the unlocking request had used the same terminal. Therefore, when the first access is made, the terminal ID of the user who made the access is stored, and if the same URL is accessed next time, the access is rejected. In other words, the advertisement image is not transmitted. When an unlock request is made with the same terminal ID, the lock is cancelled and the amount of refund is calculated. Such processing ensures adequate refund.

An item 146 represents an access time point. This indicates the time point when the user accessed advertisement data server 72 by inputting the URL. The access time point corresponds to the start time when display of the advertisement image is started. In calculating the amount of refund, the access time point is used for calculating the time period of display of the advertisement image.

An item 148 represents an unlock time point. This indicates the time point when, after the advertisement image obtained by the user inputting the URL had been locked and used as the standby image, the lock was cancelled. When the unlock time point is stored, it is understood that the corresponding advertisement image has already been unlocked. “Unlocked” means that the advertisement image had been displayed on the screen, the lock was cancelled, and the user has already received refund of the price. Specifically, when the unlock time point is stored, it can be understood that the accounting process for refunding the price in return for display of the advertisement image corresponding to the URL has already been done. Therefore, when an access is newly made to the already unlocked URL, the access is invalidated, to prevent repeated refunding of the price.

An item 150 represents the sales price of fuel cartridge to the user. This is written using the POS data processed at the time of purchase of the fuel cartridge, to prevent the amount of refund to the user from exceeding the sales price of the fuel cartridge. As described above, the amount to be returned to the user may be calculated by multiplying the time period, in which the advertisement image was used as the standby image, by a unit price per time. If the user displays the advertisement image as the standby image for a long time and the amount of refund is calculated by the simple multiplication mentioned above, the amount of refund may possibly exceed the sales price. Returning that much amount to the user does not make sense. Therefore, the sales price is stored, as the upper limit of refundable amount.

Though URL#1 has been described as an example, similar pieces of information are stored for records 152 and 154.

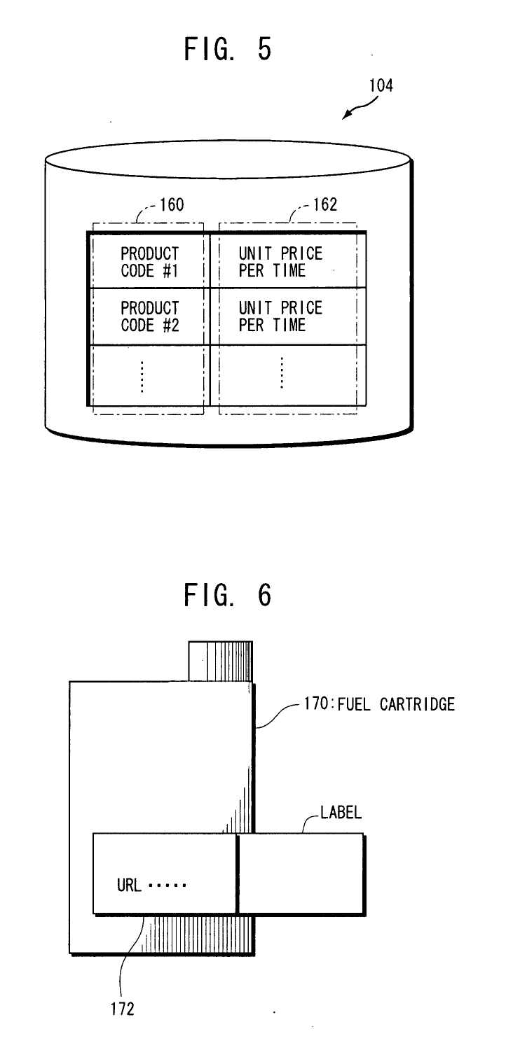

FIG. 5 shows an example of product data stored in product database 104. Referring to FIG. 5, an item 160 represents a product code. An item 162 represents information allotted to the product code. Here, the information allotted to the product code is unit price of refund per time of display of the advertisement image. Specifically, the same unit price is used for different products if they have the same product code, that is, if the products are of the same type. By multiplying the unit price of refund per time and the time period in which the advertisement image was displayed, the amount of refund to the user in return for viewing the advertisement is calculated.

Referring to FIG. 3, advertisement data server 72 further includes: a POS data reading unit 100 receiving POS data related to the fuel cartridge sold at retailer 36 from POS system 70, setting the POS flag of the corresponding URL record in URL database 102 to “1” and for writing the sales price; and a URL receiving unit 106 receiving the URL data transmitted from portable telephone 80 and outputting the received URL.

Advertisement data server 72 further includes: a URL comparing unit 108 comparing, upon reception of the URL, the received URL with URL database 102 for determining whether the image corresponding to the URL may be transmitted to portable telephone 80 or not, and performing a process in accordance with the result of determination and performing a process for writing the access time point in item 146 of the record corresponding to the URL; an image database 112 storing the image data prepared to the order of advertiser 30; and an image data transmitting unit 110 obtaining image data from image database 112 and transmitting the image data to portable telephone 80, in response to a determination by URL comparing unit 108 that the image is to be transmitted.

Advertisement data server 72 further includes a lock setting signal transmitting unit 114 for transmitting, after the image corresponding to the URL accessed by the user is transmitted to portable telephone 80, a signal for locking the image as a standby image to the portable telephone.

In order to lock the advertisement image as the standby image of portable telephone 80, the lock setting signal is transmitted to portable telephone 80 from advertisement data server 72. In response to the lock setting signal, portable telephone 80 locks the advertisement image as the standby image. In order to unlock the standby image, an unlock request signal is transmitted from portable telephone 80 to advertisement data server 72, and the unlock signal is transmitted from advertisement data server 72 to portable telephone 80. In response to the unlock signal, portable telephone 80 cancels the lock of standby image.

Advertisement data server 72 further includes: an unlock request signal receiving unit 116 receiving the unlock request signal transmitted from portable telephone 80, and writing an unlock time point to the record related to the URL stored in URL database 102; and a time calculating unit 118 for confirming, upon reception of the unlock request signal from unlock request signal receiving unit 116, whether there is any record that has the terminal ID of the portable telephone that has sent the unlock request signal and is locked and not cancelled, in URL database 102, and if any, for calculating the time period in which the advertisement image was displayed on portable telephone 80, based on the access time point in the corresponding URL record and on the time point when the unlock request signal was received. Specifically, by the cooperation of URL comparing unit 108 and time calculating unit 118, the time period in which the advertisement image was displayed on portable telephone 80 (difference between the time point when the unlock request signal was received and the access time point in the URL record) is calculated.

Advertisement data server 72 further includes: a refund amount calculating unit 120 calculating the amount to be returned to the user, by multiplying the time period calculated by time calculating unit 118 and the unit price of refund per time read from product database 104 with reference to the product code in the URL record; and an amount comparing unit 122 comparing the amount calculated by refund amount calculating unit 120 with the corresponding sales price stored in URL database 102, and outputting, to a refund instruction output unit 124, the result of calculation if the calculated amount is lower than the sales price, and the sales price if the result is not lower than the sales price, as the amount of refund. Specifically, refund amount calculating unit 120 and amount comparing unit 122 calculate the amount from the unit price of advertisement image corresponding to the product of the received URL and from the time period in which the advertisement image was displayed on the portable telephone, with the sales price of the product used as the upper limit.

Advertisement data server 72 further includes: a refund instruction output unit 124 outputting the amount of refund determined by amount comparing unit 122 to communication cost calculating unit 84 (FIG. 2); and an unlock signal transmitting unit 126 transmitting an unlock signal and the amount of refund to portable telephone 80, in response to the output of the refund instruction from refund instruction output unit 124.

FIG. 6 shows an example as to how the URL is allotted to a fuel cell. This in an example in which the URL is attached to the container of fuel cartridge of the fuel cell. Referring to FIG. 6, a label is bonded to a fuel cartridge 170 of the fuel cell. When one peels off the label, an URL 172 printed therebelow appears.

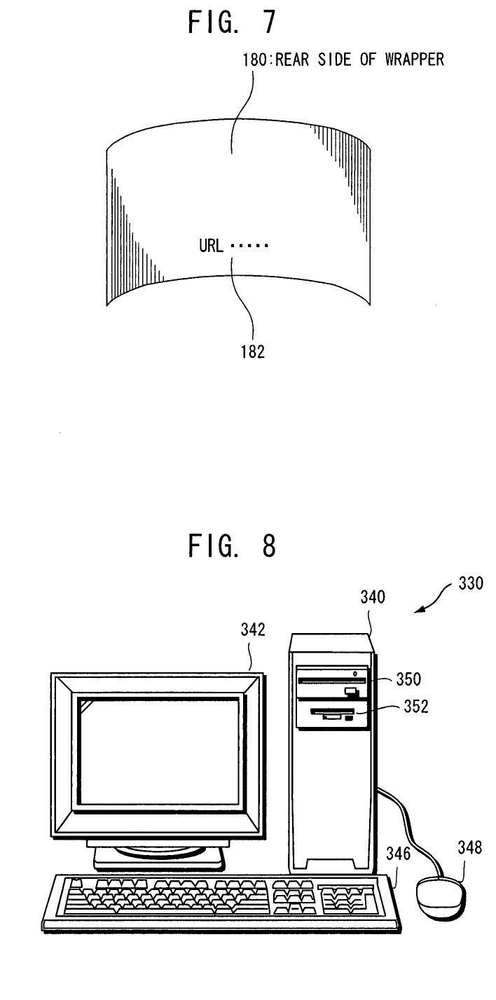

FIG. 7 shows another example as to how the URL is allotted to a fuel cell. This in an example in which the URL is attached to a wrapper of the fuel cell. Referring to FIG. 7, when one peels off the wrapper of the fuel cell, an URL 182 printed on the rear side 180 of the wrapper appears.

<Computer Implementation>

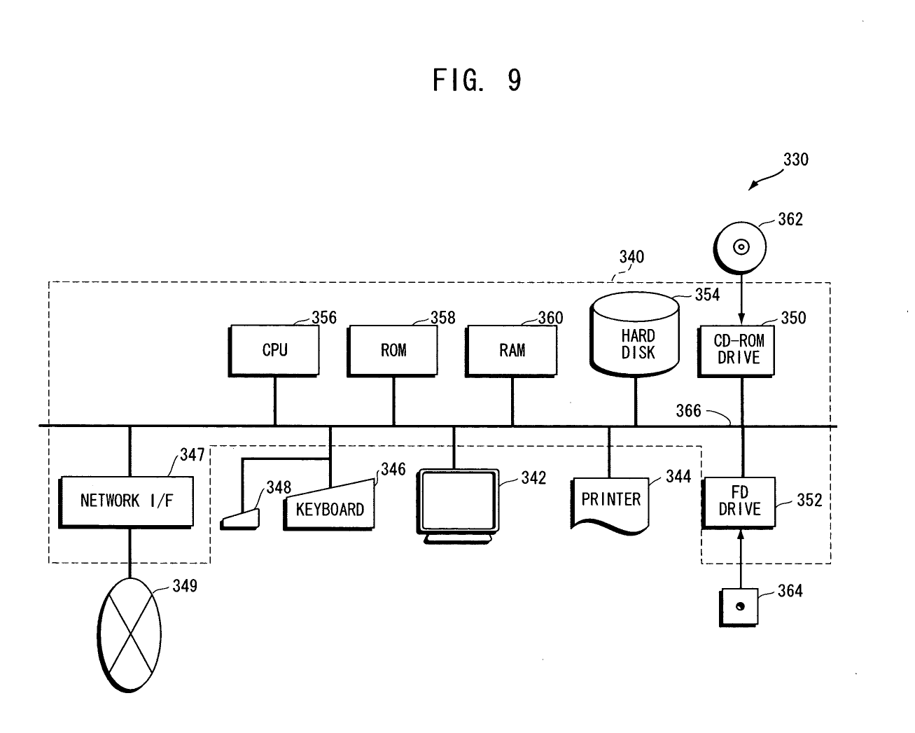

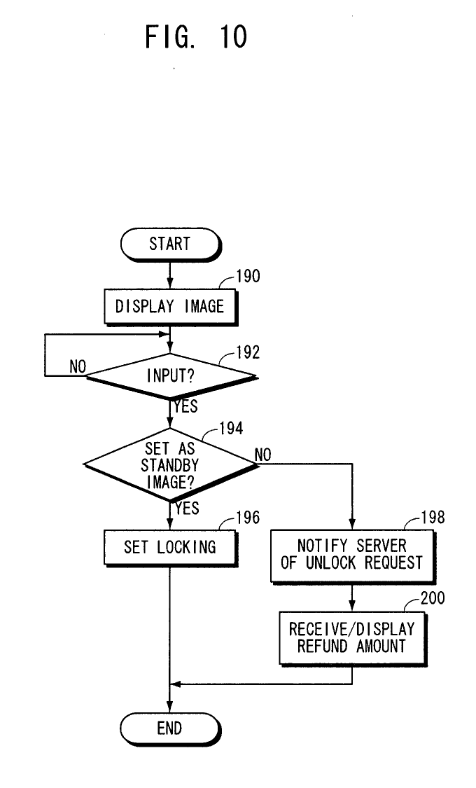

Advertisement data server 72 in accordance with the present embodiment is implemented with computer hardware, a program executed by the computer hardware, and data stored in the computer hardware. FIG. 8 shows the appearance of the computer system 330, and FIG. 9 shows an internal configuration of computer system 330.

Referring to FIG. 8, computer system 330 includes a computer 340 having an FD (Flexible Disk) drive 352 and a CD-ROM (Compact Disk Read Only Memory) drive 350, a keyboard 246, a mouse 348 and a monitor 342.

Referring to FIG. 9, computer 340 includes, in addition to FD drive 352 and CD-ROM drive 350, a CPU (Central Processing Unit) 356, a bus 366 connected to CPU 356, FD drive 352 and CD-ROM drive 350, a read only memory (ROM) 358 storing a boot-up program and the like, and a random access memory (RAM) 360 connected to bus 366 and storing program instructions, a system program, work data and the like. Computer system 330 further includes a printer 344 and a network interface 347 connected to a network 349.

Though not shown here, computer 340 may further include a network adaptor board providing connection to a local area network (LAN).

A computer program causing computer system 330 to operate as advertisement data server 72 is stored in a CD-ROM 362 or an FD 364 to be loaded to CD-ROM drive 350 or FD drive 352, and transferred to a hard disk 354. Alternatively, the program may be transmitted to computer 340 through a network, not shown, and stored in hard disk 354. The program is loaded to RAM 360 at the time of execution. The program may be loaded from CD-ROM 362, FD 364 or through the network, directly to RAM 360.

The program includes a number of instructions that causes the computer 340 to carry out the functions of advertisement data server 72 of the present embodiment. Because some of the basic functions needed to carry out the operation will be provided by the Operating System (OS) running on computer 340 or by third party programs or modules installed on computer 340, the program does not necessarily contain all of the basic functions needed for implementing the system and the method of the present embodiment. The program may need to contain only those parts of instructions that will call appropriate functions or “tools” in a controlled manner such that the desired result will be obtained, to realize the operation of advertisement data server 72 described above. How the computer system 330 operates is well known and therefore, it is not repeated here.

Portable telephone 80 in accordance with the present invention is also implemented with hardware substantially of the same configuration as a computer, a program executed by the computer hardware, and the data stored in the computer hardware. The appearance of portable telephone is different from that shown in FIG. 8. Though the configuration is slightly different as it has the telephone function, basically, a common portable telephone hardware can be used.

When the process at advertisement data server 72 and portable telephone 80 is to be realized by a computer program, a lock setting process program and an unlock program for portable telephone 80, as well as lock setting process program and an unlock program for advertisement data server 72 are necessary. Control structures of these four programs will be described in the following, with reference to flowcharts.

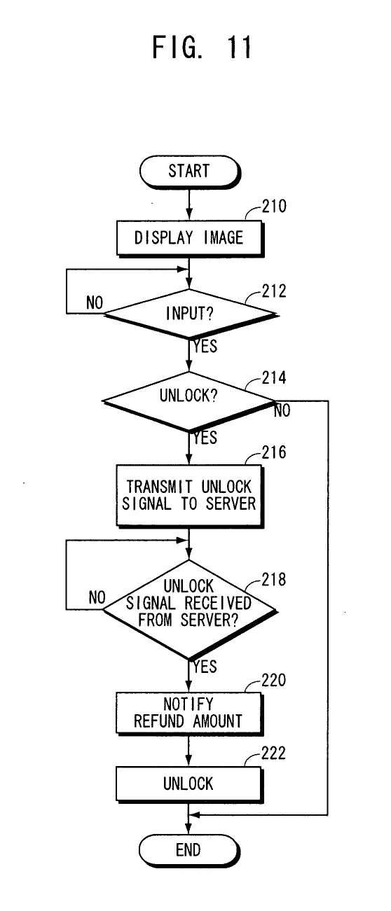

FIG. 10 is a flowchart representing a control structure of a computer program for realizing the lock setting process at portable telephone 80 by the computer program. The program is activated when the advertising image is sent to portable telephone 80 from advertisement data server 72 and the lock setting signal is further transmitted.

Referring to FIG. 10, when the process starts, at step 190, a query image is displayed on a screen 90 for setting the image transmitted from advertisement data server 72 to portable telephone 80 as the standby image.

At step 192, whether a key input has been made through a key board 92 of portable telephone 80 or not is determined. If there has been no input, the flow returns to step 192 to wait for an input. If there has been an input, the flow proceeds to step 194.

At step 194, whether the user selected, by a key input, setting of the image transmitted to portable telephone 80 as the standby image or not is determined. If setting as the standby image has been selected, the flow proceeds to step 196, and if not, the flow proceeds to step 198.

At step 196, the advertisement image is set as the standby image and locked. Then, the process ends.

If the user selected not to set the image transmitted to portable telephone 80 as the standby image, an unlock request signal is sent to advertisement data server 72 at step 198. Then, the process proceeds to step 200.

At step 200, in response to the unlocking, the amount of refund calculated by advertisement data server 72 based on the time period in which the advertisement image was displayed on screen 90 of portable telephone 80 is received and the amount is displayed on screen 90 of portable telephone 80. Then, the process ends.

Specifically, by the program shown in FIG. 10, the process for locking the advertisement image transmitted from advertisement data server 72 to portable telephone 80 as the standby image of portable telephone 80 is realized.

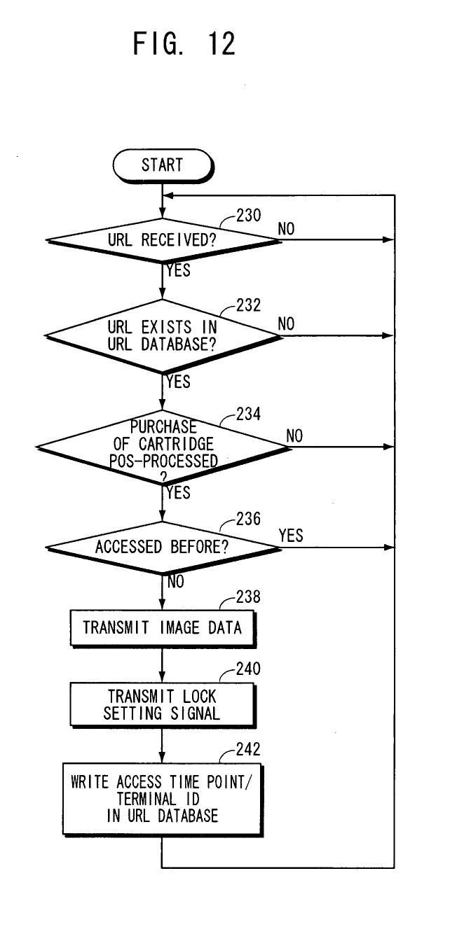

FIG. 11 is a flowchart representing a control structure of a computer program for realizing the unlocking process at portable telephone 80 by the computer program. Referring to FIG. 11, at step 210, a query image is displayed on a screen 90 of portable telephone 80 for unlocking. Then, the process proceeds to step 212.

At step 212, whether there is a key input from keyboard 192 of portable telephone 80 or not is determined. If there is no key input, the flow returns to step 212 to wait for an input. If there is an input, the flow proceeds to step 214.

At step 214, whether the unlock input has been made by the user or not is determined. If there has been an unlock input, the flow proceeds to step 216. If there is no unlock input, that is, continuous locking is selected, the process ends.

At step 216, upon reception of the unlock input, the unlock request signal is transmitted to advertisement data server 72.

At step 218, whether the unlock signal has been received from advertisement data server 72 or not is determined. If it has not been received, the flow returns to step 218, to wait for the input. If it has been received, the flow proceeds to step 220.

At step 220, the amount of refund calculated by advertisement data server 72 and transmitted therefrom is displayed on screen 90 of portable telephone 80.

At step 222, the advertisement image set as the standby image is unlocked. Then, the process ends.

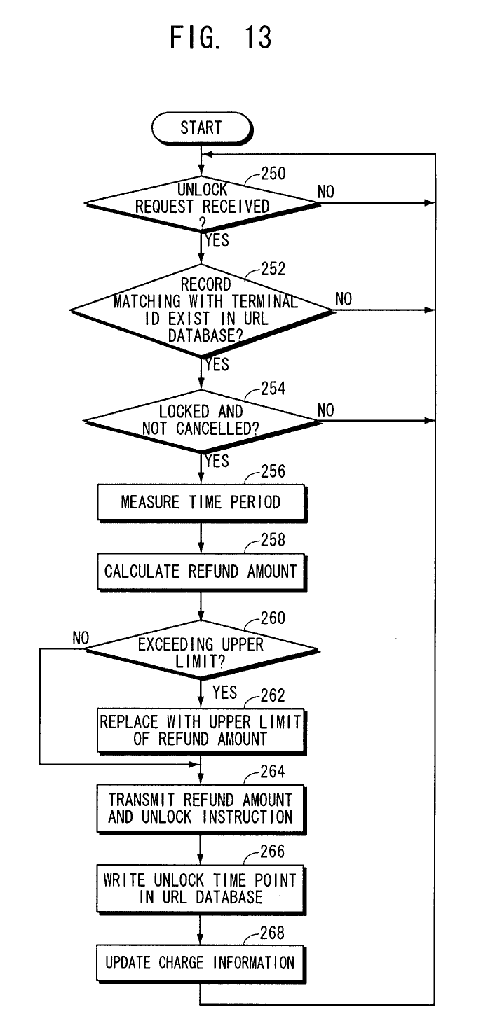

FIG. 12 is a flowchart representing a control structure of a computer program for realizing the lock setting process at advertisement data server 72 by the computer program. Referring to FIG. 12, at step 230, whether an access request designating a URL has been received or not is determined. If it has been received, the flow proceeds to step 232. If not, the flow returns to step 230, to wait for the input.

At step 232, whether there is a record of the same URL entry as the received URL in URL database 102 or not is determined. If there is a record of the same URL entry, the flow proceeds to step 234. If not, the flow returns to step 230, again to wait for an input of URL.

At step 234, whether the POS flag of the record having the same URL entry as the received URL is “1” or not is determined, and based on the result of determination, whether the purchase of the fuel cartridge of the fuel cell has been subjected to POS or not is determined. In other words, whether the corresponding fuel cell has been sold or not is determined. If the POS flag is “1”, the flow proceeds to step 236. If the POS flag is “0”, the flow returns to step 230, to wait for another input of URL.

At step 236, whether the data held in URL database 102 has a terminal ID of the person who made the access stored therein or not is determined. If the ID is not stored, that is, when it is empty, the flow proceeds to step 238. If it is stored, the flow returns to step 230, to wait for another input of URL.

The process of steps 232 to 236 corresponds to the function of URL comparing unit 108.

At step 238, the image data determined by the received URL is read from image database 112 and transmitted from image data transmitting unit 110 to portable telephone 80.

At step 240, the lock setting signal is transmitted from lock setting signal transmitting unit 114.

At step 242, the access time point and the terminal ID of the terminal that made the access are stored in URL database 102. After the end of this process, the flow returns to step 230, to wait for another input of URL.

FIG. 13 is a flowchart representing a control structure of a computer program for realizing the unlocking process at advertisement data server 72 by the computer program. Referring to FIG. 13, at step 250, whether the unlock request has been received from portable telephone 80 or not is determined. This corresponds to the function of unlock request signal receiving unit 116. If the unlock request has been received, the flow proceeds to step 252. If not, the flow returns to step 250, to wait for the reception.

At step 252, whether there is a record matching the terminal ID of the terminal that has transmitted the unlock request in URL database 102 or not is determined. If there is a matching record, the flow proceeds to step 254. If there is no match, the flow returns to step 250, to wait for a reception of the unlock request.

At step 254, if the terminal ID of the person who made the access and the access time point are already stored in the record of URL database 102 and the value of unlock time point is empty, the flow proceeds to step 256. Otherwise, the flow returns to step 250.

At step 256, the access time point stored in URL database 102 and the time point of reception of the unlock request signal are read, and from the difference between these two time points, the time period of display of the advertisement image is calculated. Then, the flow proceeds to step 258.

The process of steps 252 to 256 corresponds to the function of time calculating unit 118.

At step 258, using the time calculated at step 256 and the unit price per time held in product database 104, the amount to be returned to the user is calculated. This corresponds to the function of refund amount calculating unit 120. Then, the process proceeds to step 260.

At step 260, whether the amount calculated at step 258 is not lower than the sales price held in URL database 102 or not is determined. This corresponds to the function of amount comparing unit 122. If the amount is not lower than the sales price, the flow proceeds to step 262, and if it is lower than the sales price, the flow proceeds to step 264.

At step 262, the amount of refund is replaced with the sales price of fuel cartridge. Then, the process proceeds to step 264.

At step 264, the amount of refund and the unlock instruction are transmitted to portable telephone 80. This corresponds to the function of unlock signal transmitting unit 126. Then, the flow proceeds to step 266.

At step 266, the unlock time point is written to the record read at step 252, and the URL database 102 is updated. Then, the process proceeds to step 268.

At step 268, the amount of refund is given to communication cost calculating unit 84, and the amount of refund is added to the item “refund” of charge information for the user 38. After the end of this step, the flow returns to step 250.

[Operation]

Referring to FIGS. 1 to 3, the operation of advertisement data server 72 will be described in the following. First, advertiser 30 (see FIG. 1) makes an order 40 to telecommunications company 32 to place an advertisement, and pays cost 42 to run the advertisement. Telecommunications company 32 prepares advertisement data including an advertisement image formed to the order 40, and stores the data in advertisement data server 72. Further, telecommunications company passes URL data 46 of the advertisement data stored in advertisement data server 72 to a fuel cartridge manufacturer 34, and pays printing fee 48.

Receiving the URL data 46, the fuel cartridge manufacturer 34 manufactures a fuel cartridge having URL printed on its container or wrapping. Further, cartridge manufacturer 34 sells fuel cartridge 50 to retailer 36, and receives payment of fuel cartridge price 52. Retailer 36 sells the fuel cartridge to a user 38 and receives fuel cartridge price 56. At the time of selling fuel cartridge 54 to user 38, POS system 70 reads information of the fuel cartridge 54 from the container or the wrapper, and transmits the information to advertisement data server 72.

User 38 (see FIG. 1) who bought fuel cartridge 54 inputs URL printed on the container or wrapper of fuel cartridge through the keyboard of portable telephone 80, and transmits the URL to advertisement data server 72.

The transmitted URL is received by URL receiving unit 106 (see FIG. 3), and applied to URL comparing unit 108. URL comparing unit 108 is connected to URL database 102, and it determines whether there is a record having the same URL entry as the applied URL in URL database 102. If there is a record having the same URL entry in URL database 102, the URL record is read.

URL comparing unit 108 compares the contents of the read URL record. Specifically, first, whether the value of POS flag in the record is “1” or not is determined. If the POS flag is “1”, POS processing has been done, and if it is “0”, the POS process is not yet done.

If the POS flag is “0”, the advertisement image corresponding to the URL is determined not to be transmitted to portable telephone 80. In other words, the request is denied.

If the POS flag is “1”, whether the terminal ID of the URL record read by URL comparing unit 108 is empty or not is determined. The terminal ID of the person who made the access is stored in the URL record when the URL is first accessed by portable telephone 80. By the comparison, whether the URL was accessed before or not is determined.

In order to avoid unfair refund such as double payment, advertisement image corresponding to the URL is determined not to be transmitted to portable telephone 80 if the terminal ID thereof has already been written.

If the POS flag of URL record in URL database 102 is “1” and the item of terminal ID is empty, URL comparing unit 108 requests image data transmitting unit 110 to send the image corresponding to the URL to portable telephone 80, and further, writes the terminal ID of the person who made the access and the access time point in the corresponding URL record in URL database 102. Receiving the request, image data transmitting unit 110 reads the advertisement image corresponding to the URL from image database 112, and transmits the advertisement image to portable telephone 80.

URL comparing unit 108 further requests lock setting signal transmitting unit 114 to transmit the lock setting signal for locking the advertisement image as the standby image of portable telephone 80. Receiving the request, lock setting signal transmitting unit 114 transmits the lock setting signal to portable telephone 80. In portable telephone 80 that received the lock setting signal, the advertisement image transmitted from image data transmitting unit 110 is displayed as the standby image, and the image is locked. The locked advertisement image is continuously displayed as the standby image of portable telephone 80 until unlocked by the user.

Next, assume that the user 38 wishes to unlock the advertisement image set as the standby image. Then, user 38 first displays an image for unlocking on screen 90, and selects “unlock” through the keyboard. By this input, an unlock request signal is transmitted to advertisement data server 72.

The transmitted unlock request signal is received by unlock request signal receiving unit 116. Unlock request signal receiving unit 116 determines whether there is a record matching the terminal ID of the terminal that transmitted the unlock request signal, in URL database 102. If there is a matching record, whether the record has been locked or not is determined. If the record is locked (not yet unlocked), the record is the object of the pending unlock request signal. Therefore, the record is read, and the applied from unlock request signal receiving unit 116 to time calculating unit 118.

In response, time calculating unit 118 calculates the time period in which the advertisement image was displayed on screen 90 of portable telephone 80, from the read access time point and the time point when the unlock request signal was received. The calculated time period and the product code in the corresponding record are applied from time calculating unit 118 to refund amount calculating unit 120.

Refund amount calculating unit 120 is connected to product database 104, reads unit price per time from the record corresponding to the product code applied from time calculating unit 118, and by multiplying the time period calculated by time calculating unit 118 and the unit price, calculates the amount to be refund to the user in return for the display of advertisement image. The calculated amount is applied to amount comparing unit.

Amount comparing unit 122 compares the price calculated at refund amount calculating unit 120 with the sales price. If the calculated price is lower than the sales price, the calculated price is applied as the amount of refund, to refund instruction output unit 124, as the amount of refund.

Refund instruction output unit 124 outputs the applied refund amount to communication cost calculating unit 84. In response to transmission of the signal from refund instruction output unit 124 to communication cost calculating unit 84, unlock signal transmitting unit 126 transmits the amount of refund applied from amount comparing unit 122 and the unlock signal to portable telephone 80. Further, unlock signal transmitting unit 126 stores the time point when the unlock signal was transmitted, as the unlock time point, in URL database 102.

In portable telephone 80 receiving the unlock signal and the amount of refund, the advertisement image that has been set as the standby image is unlocked. Further, the applied amount of refund is displayed on screen 90 of portable telephone 80, so as to notify the user 38 of the amount of refund made in return for the display of the advertisement image.

Receiving the amount of refund, communication cost calculating unit 84 (see FIG. 2) records and accumulates itemized records of monthly refund. At this time of recording, items such as the sponsor code, terminal ID of the person who made the access and the like are also recorded.

On a specific cut-off date, communication cost calculating unit 84 outputs the accumulated amount of refund together with the breakdown of refund amounts, to advertiser 30. Further, communication cost calculating unit 84 reads call log of a user from call log database 86, and calculates the communication fees. Communication cost calculating unit 84 further sums up user-by-user amounts of refund from the itemized records, subtracts the total amount of refund from the calculated communication fees and obtains the difference. User 38 is notified of the calculated difference as the communication fees. Through the above-described process, the user can be reimbursed for the cost of fuel cartridge in the form of reduced communication fees.

In the present embodiment, unit price per time held in product database 104 is used to calculate the amount of refund. The method of determining the amount of refund, however, is not limited to multiplication of unit price per time and the time period of display of the advertisement image. By way of example, a prescribed time period may be held as a record, other than the unit price per time, as the product code. According to this method, after the lapse of the prescribed time period, there is no charge for the fuel cartridge, and in this manner, the amount of refund to user 38 is determined.

In the present embodiment, for accessing advertisement data server 72, the user manually inputs the URL printed on the container or wrapper of the fuel cartridge. The method is not limited to manual input and transmission of the URL. By way of example, a QR (quick response) code® may be printed on the container or wrapper of the fuel cartridge, and the code may be picked-up by a camera of portable telephone 80 as a camera-phone, to make an access to advertisement data server 72.

In the present embodiment, an example has been described in which unit price per time is determined for each fuel cartridge as a product. Here, the amount of refund is calculated type by type of the product. The method of calculating the amount of refund, however, is not limited to this method. By way of example, the advertisement images may be grouped according to the types in advance, and the unit price per time for each group may be determined. Here, the amount of refund is calculated group by group of the advertisement images.

When the advertisement data server 72 of the present embodiment is adopted, it is unnecessary to add any extra element to portable telephone 80 or the like as the advertisement medium, for transmitting and displaying the advertisement. Therefore, extra cost for displaying the advertisement is unnecessary.

Further, as the advertisement image is displayed as the standby image, it is assured that user 38 recognizes the advertisement image before operating portable telephone 80. Therefore, the advertisement image is viewed frequently by user 38, attaining high effect of advertisement.

As described above, it is possible to provide advertisement data server 72 realizing a system in which advertisement information can be transmitted to user 38 by a simple arrangement, and the cost of fuel can be taken over by an advertiser 30 in return for sending highly effective advertisement to the user 38.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

What is claimed is:

1. An apparatus for distributing advertisement to a terminal on a network, comprising:
first storage means for individually storing a flag indicating whether each of a plurality of products has been sold or not by first and second values, respectively;
determining means responsive to an access from outside designating prescribed information allotted to said plurality of products and different for different products, for determining whether the product specified by said prescribed information has been sold or not, by making reference to said first storage means;
transmitting means responsive to a determination by said determining means that the corresponding product has been sold, for transmitting an advertisement image prepared beforehand to a terminal that made the access;
measuring means for measuring a time period in which said advertisement image is displayed on said terminal, through communication with said terminal; and
amount calculating means for calculating an amount to be paid back to an owner of said terminal in return for viewing said advertisement image, based on the time period measured by said measuring means and on said prescribed information.

2. The apparatus according to claim 1, wherein
said first storage means further stores a sales price of said product;
said apparatus further comprising
second storage means for storing, type by type of said products, unit price of said advertisement image; and wherein
said amount calculating means includes means for calculating said amount from said unit price of said advertisement image corresponding to the product specified by said prescribed information and on the time period in which said advertisement image is displayed on said terminal, with the sales price of the product specified by said prescribed information being an upper limit.

3. The apparatus according to claim 1, wherein
said first storage means further stores a sales price of said product;
said apparatus further comprising
second storage means for storing, type by type of said advertisement image, unit price of said advertisement image; and wherein
said amount calculating means includes means for calculating said amount from said unit price of said advertisement image transmitted to said terminal and on the time period in which said advertisement image is displayed on said terminal, with the sales price of the product specified by said prescribed information being an upper limit.

4. The apparatus according to claim 1, further comprising
accounting means for performing a prescribed accounting process for paying said amount calculated by said amount calculating means to the owner of said terminal.

5. The apparatus according to claim 4, wherein
said first storage means further stores, for individual product, payment complete information for identifying whether the process for payment by said accounting means has been complete or not;
said determining means includes means responsive to reception of said prescribed information for making reference to said first storage means and for determining whether the product specified by said prescribed information has been sold and the process for payment is complete or not; and
said transmitting means includes means responsive to a determination by said determining means that the corresponding product has been sold and the process for payment by said accounting means has not yet been complete on the product, for transmitting said advertisement image prepared beforehand, to said terminal that made the access.

6. The apparatus according to claim 5, wherein
said payment complete information indicates whether the process for payment by said accounting means has been complete or not by being non-empty or empty;
said apparatus further comprising
updating means for updating said payment complete information of the product for which said process for payment has been completed by said accounting means, to a prescribed value other than empty.

7. The apparatus according to claim 6, wherein
said transmitting means includes
means for transmitting said advertisement image to said terminal,
means for transmitting to said terminal a lock signal instructing said terminal to lock an image displayed on said terminal to said advertisement image, and
time storage means for storing time point when said advertisement image was transmitted to said terminal;
said measuring means includes
unlocking means responsive to reception of an unlock request signal requesting unlocking of the displayed image from said terminal, for transmitting to said terminal an unlock signal instructing said terminal to unlock the displayed image, and
means for calculating difference between the time point stored in said time storage means and the time point when said unlock request signal is received; and
said updating means includes
means responsive to transmission of said unlock signal to said terminal for writing the time point when said unlock signal is transmitted, in said payment complete information.

8. The apparatus according to claim 7, wherein
said first storage means stores, for each of said plurality of products, access presence/absence information indicating whether an access designating said prescribed information corresponding to the product has been made or not; and
said apparatus further comprising
means responsive to an access designating said prescribed information from the outside, for writing identification information of a terminal that made the access in the access presence/absence information, if said access presence/absence information of the product specified by said prescribed information is empty.

9. The apparatus according to claim 8, wherein
said unlocking means includes
means responsive to reception of an unlock request signal requesting unlocking of the displayed image designating said prescribed information from said terminal, for transmitting said unlock signal to said terminal, when identification information of the terminal that transmitted said unlock request signal matches identification information of the terminal stored in said access presence/absence information of the product specified by said prescribed information, in said first storage means.

10. The apparatus according to claim 9, further comprising
means responsive to reception of an unlock request signal requesting unlocking of the displayed image designating said prescribed information from said terminal, for controlling said unlocking means such that said unlock signal is not transmitted to said terminal, when identification information of the terminal that transmitted said unlock request signal does not match the identification information of the terminal stored in said access presence/absence information of the product specified by said prescribed information, in said first storage means.

11. The apparatus according to claim 6, further comprising
means responsive to said payment complete information not being empty for the product corresponding to said prescribed information in said first storage means upon reception of said prescribed information from the outside, for controlling said transmitting means not to transmit said advertisement image.

12. The apparatus according to claim 4, further comprising
means for calculating usage fee of a prescribed service by a terminal on said network and charging the user of each terminal for the fee in every prescribed billing period; wherein
said accounting means includes means for reducing the amount calculated by said amount calculating means from the usage fee of the service charged against the user of each terminal.

13. The apparatus according to claim 4, further comprising
billing means for summing up the amounts subjected to the process for payment by said accounting means for each client of transmitted advertisement and billing each client for the sum.

14. The apparatus according to claim 1, wherein
said transmitting means includes
means for transmitting said advertisement image to said terminal,
means for transmitting to said terminal a lock signal instructing said terminal to lock an image displayed on said terminal to said advertisement image, and
time storage means for storing the time point when said advertisement image is transmitted to said terminal; and
said measuring means includes
unlocking means responsive to reception of an unlock request signal requesting unlocking of the displayed image from said terminal, for transmitting an unlock signal to said terminal instructing unlocking of the displayed image, and
means for calculating difference between the time point stored in said time storage means and the time point when said unlock request signal was received.

15. The apparatus according to claim 1, further comprising
means for recording, every time a product sales data is received from a retailer of said product, a sales price of the corresponding one of said plurality of products in accordance with the sales data, and for updating the value of said flag corresponding to said product to said first value.

16. The apparatus according to claim 1, further comprising
means for transmitting information representing the amount calculated by said amount calculating means to the terminal that made the access.

17. The apparatus according to claim 1, wherein
said product is a fuel cell cartridge.

18. The apparatus according to claim 1, wherein
said prescribed information includes Uniform Resources Locator uniquely determined for each of said plurality of products.

19. A computerized method of distributing advertisement to a terminal on a network, comprising the steps of:
connecting to first storage means for individually storing a flag indicating whether each of a plurality of products has been sold or not by first and second values, respectively;
determining, in response an access designating prescribed information allotted to said plurality of products and different for different products from outside, whether said flag of the product specified by said prescribed information has said first value or not, by making reference to said first storage means;
transmitting, in response to determination at said determining step that said flag of the corresponding product has said first value, an advertisement image prepared beforehand to a terminal device that made the access;
measuring a time period in which said advertisement image is displayed in said terminal device, through communication with said terminal device; and
calculating, based on said prescribed information and the time period measured at said measuring step, an amount to be paid to an owner of said terminal device in return for viewing said advertisement image.

20. A computer program product having a computer-readable medium having recorded thereon a computer program for distributing advertisement to a terminal on a network, wherein
said computer program product includes
first program code means for connecting to first storage means in the computer for individually storing a flag indicating whether each of a plurality of products has been sold or not by first and second values, respectively,
second program code means responsive to an access designating prescribed information allotted to said products and different for different products from outside, for determining whether said flag of the product specified by said prescribed information has been sold or not, by making reference to said first storage means,
third program code means responsive to determination by said second program code means that the corresponding product has been sold, for transmitting an advertisement image prepared beforehand to a terminal device that made the access,
fourth program code means for measuring a time period in which said advertisement image was displayed in said terminal device, through communication with said terminal device, and
fifth program code means for calculating, based on said prescribed information and the time period measured at said measuring step, an amount to be paid to an owner of said terminal device in return for viewing said advertisement image.
